(19) United States
(12) Patent Application Publication
(10) Pub. No.: US 2013/0112025 A1
(43) Pub. Date: May 9, 2013

(54) BALL SCREW ASSEMBLY BASED ON HEAT-PIPE THERMAL DISSIPATION

(71) Applicants: Yeau-Ren Jeng, Tainan City (TW); Yu-Xian Huang, Tainan City (TW)

(72) Inventors: Yeau-Ren Jeng, Tainan City (TW); Yu-Xian Huang, Tainan City (TW)

(21) Appl. No.: 13/363,902

(22) Filed: Feb. 1, 2012

(30) Foreign Application Priority Data
Nov. 9, 2011 (TW) 100140919

(51) Int. Cl. F16H 25/22

(52) U.S. Cl. 74/424.81

(57) ABSTRACT

A ball screw assembly based on heat-pipe thermal dissipation is composed of a ball screw and at least one heat pipe. The ball screw includes a threaded shaft, a nut, and a plurality of balls mounted between the threaded shaft and the nut. The at least one heat pipe defines a main body and an extended part. The main body is mounted to the ball screw. The extended part extends outwardly for a predetermined length from the ball screw for thermal dissipation or connection with a heat-dissipating device.

### BACKGROUND OF THE INVENTION

1. Field of the Invention

The present invention relates generally to a linearly movable device, and more particularly, to a ball screw assembly based on heat-pipe thermal dissipation.

2. Description of the Related Art

A conventional ball screw is composed of a threaded shaft, a nut, and a plurality of circulative balls inserted between the threaded shaft and the nut in such a way that the linear movement of the ball screw can have very high precision.

However, the movement of the balls inside the threaded shaft is very sensitive to temperature rise. When the regional temperature rise reaches 20 degrees or more, the stroke of the threaded shaft per one meter may have the error reaching 100 μm. If the movement is faster, the thermal energy will be greater to make the working environment and the positioning precision face stricter test. Thus, if it is intended to solve the problem of temperature rise, additional thermal dissipation will be needed.

The conventional thermal dissipation for the ball screw is almost based on liquid cooling, i.e. a cooling channel is created inside the nut for a cooling liquid and the thermal energy of the nut can be conducted outward by the backflow of the cooling liquid. For example, such prior art is applied to a nut for a cooling device as disclosed in Taiwan Pat. Pub. No. 200637986.

Since the aforesaid prior art is liquid-based, it needs a pipeline and must avoid leakage. If the assembly is deficient or parts thereof are shabby, leakage or even contamination will happen.

### SUMMARY OF THE INVENTION

The primary objective of the present invention is to provide a ball screw assembly, which can outwardly conduct the heat generated, while the ball screw is operated, through a heat pope and does not have the problem of liquid leakage or contamination as the prior art has.

The secondary objective of the present invention is to provide a ball screw assembly, which can outwardly conduct the heat generated, while the ball screw is operated, more quickly than the prior art.

The foregoing objectives of the present invention are attained by the ball screw assembly composed of a ball screw and at least one heat pipe. The ball screw includes a threaded shaft, a nut, and a plurality of balls mounted between the threaded shaft and the nut. The at least one heat pipe defines a main body and an extended part, the main body being mounted to the ball screw, the extended part extending outwardly for a predetermined length from the ball screw for thermal dissipation or connection with a heat-dissipating device.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a sectional view taken along a line 3-3 indicated in FIG. 1.

FIG. 4 is a sectional view of a part of a second preferred embodiment of the present invention.

FIG. 5 is a sectional view of a part of a third preferred embodiment of the present invention.

FIG. 6 is a perspective view of a fourth preferred embodiment of the present invention.

FIG. 7 is a sectional view of a part of a fifth preferred embodiment of the present invention.

FIG. 8 is a perspective view of a sixth preferred embodiment of the present invention.

FIG. 9 is a sectional view of a part of a seventh preferred embodiment of the present invention

### DETAILED DESCRIPTION OF PREFERRED EMBODIMENTS

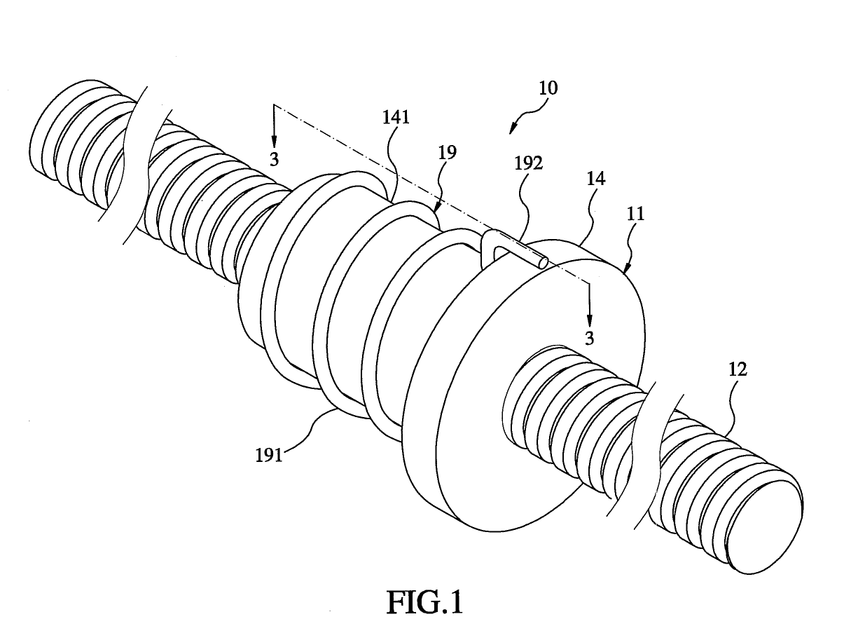

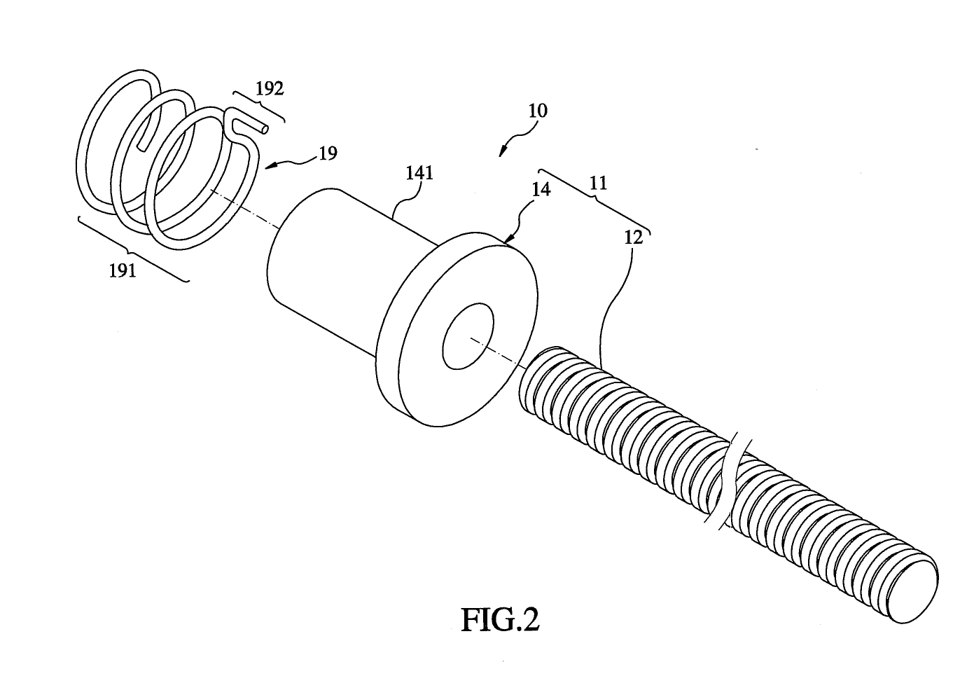

Referring to FIGS. 1-3, a ball screw assembly 10 based on heat-pipe thermal dissipation in accordance with a first preferred embodiment of the present invention is composed of a ball screw 11 and a heat pipe 19. The detailed descriptions and operations of these elements as well as their interrelations are recited in the respective paragraphs as follows.

The ball screw 11 includes a threaded shaft 12, a nut 14, and a plurality of balls 16 mounted between the threaded shaft 12 and the nut 14. The nut 14 has a barrel 141.

The heat pipe 19 defines a main body 191 and an extended part 192 extending outwardly for a predetermined length from the ball screw 11 for thermal dissipation.

In the first preferred embodiment, the main body 191 of the heat pipe 19 is spirally mounted to an external surface of the barrel 141 by solder 99, such as soldering tin. The extended part 192 extends toward a direction away from the nut 14.

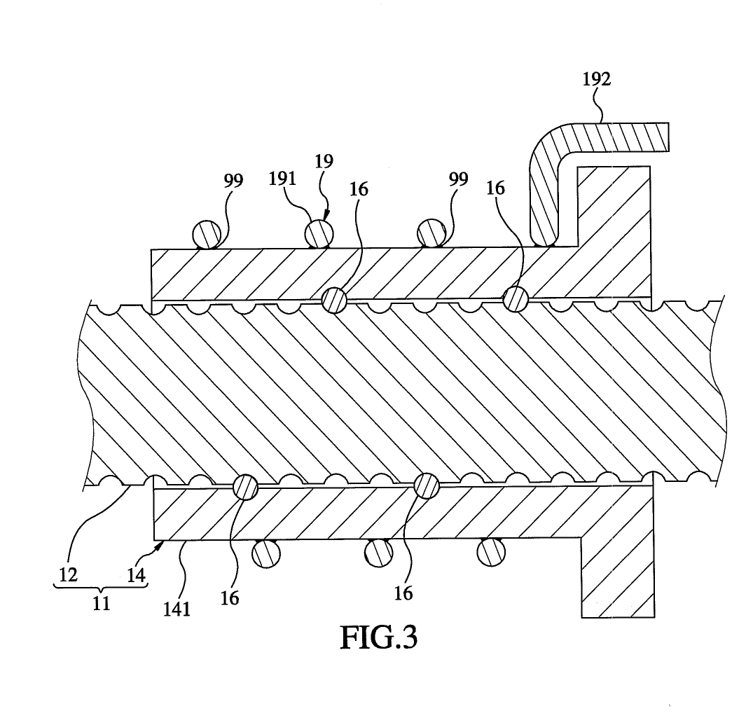

Referring to FIGS. 1 and 3, when the ball screw 11 is operated, the threaded shaft 12 is rotated to drive the nut 14 to move along an axial direction of the threaded shaft 12. During the operation of the ball screw 11, heat is generated and can increase the temperature of the nut 14. High-speed temperature equalization is characteristic of the heat pipe 19, so the heat pipe 19 can conduct the heat to the extended part 192 quickly. As the nut 14 is moved, the extended part 192 can be moved in the air and the air can take the heat away at the same time for purpose of thermal dissipation.

As indicated above, the heat pipe 19 of the present invention can outwardly conduct the heat generated while the ball screw 11 is operated and none of any cooling liquid is applied to the present invention, so there will be no problem of liquid leakage or contamination as it would happen in the prior art. Besides, the present invention can outwardly conduct the heat generated by the ball screw 11 more quickly than the prior art.

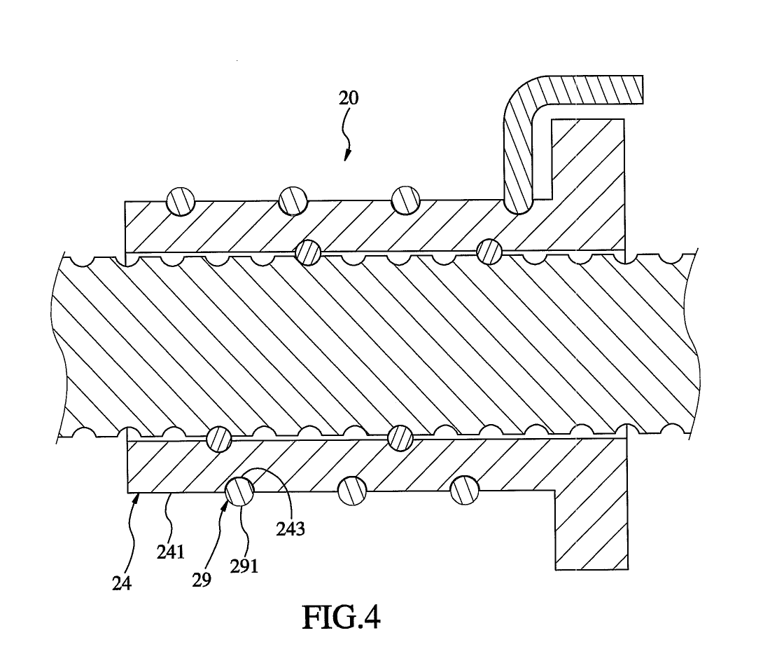

Referring to FIG. 4, a ball screw assembly 20 based on heat-pipe thermal dissipation in accordance with a second preferred embodiment of the present invention similar to that of the first embodiment, having the differences recited in the following paragraphs.

The barrel 241 of the nut 24 is provided with a spiral groove 243 formed on a surface thereof. The main body 291 is wedged into the spiral groove 243. The spiral groove 243 is arc-shaped in sectional view to have its bottom side fit an external surface of the heat pipe 29. In this way, the bottom side of the spiral groove 243 can contact the external wall of the heat pipe 29 to transfer the heat to the heat pipe 29.

The spiral groove 243 can allow the main body 291 to be wedged therein to well position the main body 291. Besides, the heat pipe 29 can be wedged into the spiral groove 243 without any solder to be well positioned.

In addition, the radian of the spiral groove 243 in sectional view does not need to fit that of the external surface. If the radian of the spiral groove 243 is larger, the heat pipe 29 can be partially or fully wedged into the spiral groove 243 for the same purpose of being well positioned. In other words, it is not limited for the radian of the spiral groove 243 to fit that of the external surface of the heat pipe 29.

The other structural features and effects of the second embodiment are identical to those of the first embodiment, so further recitation is skipped.

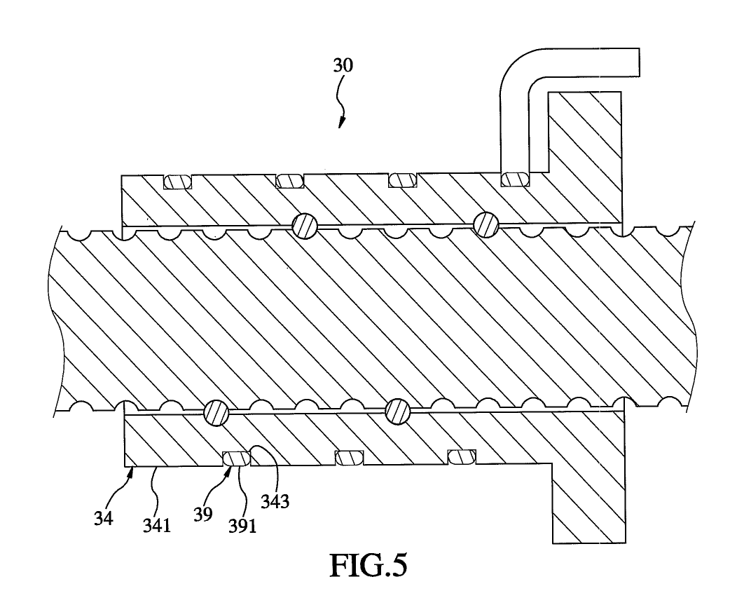

Referring to FIG. 5, a ball screw assembly 30 based on heat-pipe thermal dissipation in accordance with a third preferred embodiment of the present invention is similar to that of the second preferred embodiment, having the differences recited in the following paragraphs.

The bottom side of the spiral groove 343 is flat.

The heat pipe 39 is squeezed to have two flat external surfaces opposite to each other. The spiral groove 343 is higher than the heat pipe 39, so the main body 391 has one of the two flat external surfaces thereof cling to the bottom side of the spiral groove 343 without protruding beyond the external surface of the barrel 341.

The other structural features and effects of the third embodiment are identical to those of the second embodiment, so further recitation is skipped.

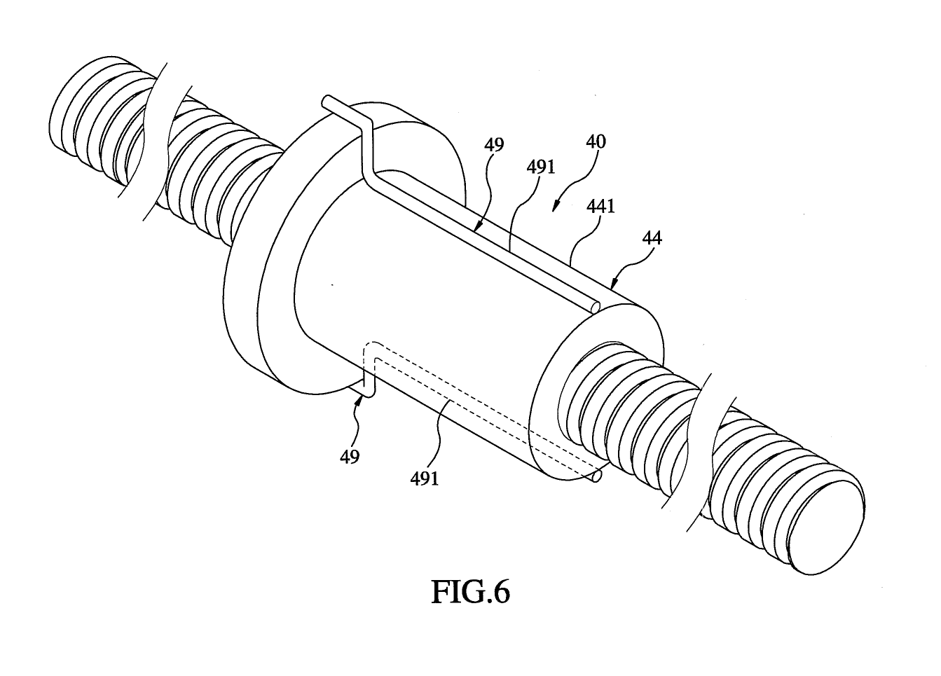

Referring to FIG. 6, a ball screw assembly 40 based on heat-pipe thermal dissipation in accordance with a fourth preferred embodiment of the present invention is similar to that of the first preferred embodiment, having the differences recited in the following paragraphs.

There are two heat pipes 49 in this embodiment. Each of the heat pipes 49 has the main body 491 be mounted onto the nut. The main body 491 of each heat pipe 49 is not spirally mounted to the barrel 441 of the nut 44 but linearly soldered onto the external surface of the barrel 441 by solder (now shown). Thus, the main body 491 of the heat pipe 49 is not limited to the spiral shape.

The other structural features and effects of the fourth embodiment are identical to those of the first embodiment, so further recitation is skipped.

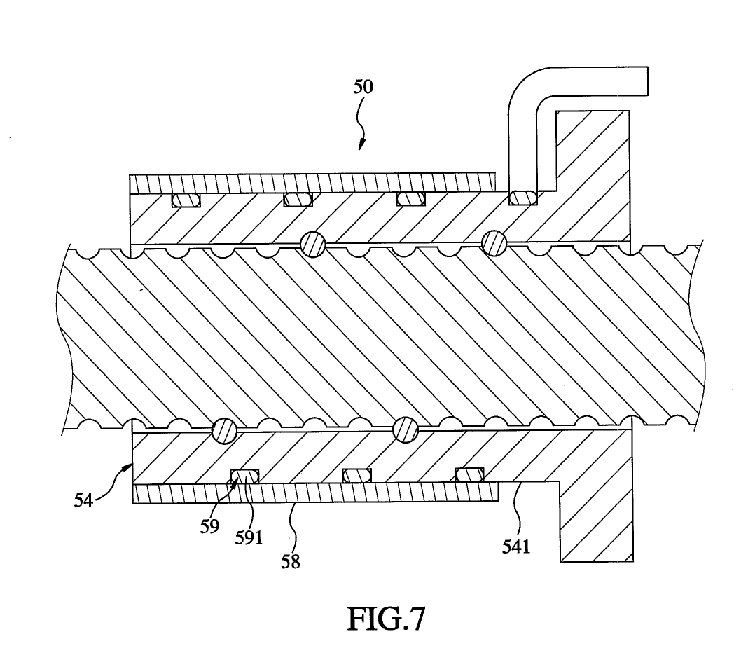

Referring to FIG. 7, a ball screw assembly 50 based on heat-pipe thermal dissipation in accordance with a fifth preferred embodiment of the present invention is similar to that of the third preferred embodiment, having the differences recited in the following paragraphs.

The ball screw assembly 50 further includes a sleeve 58 sleeved onto the barrel 541 of the nut 54 and covering the main body 591 of the heat pipe 59. In this way, the heat pipe 59 is not exposed outside.

In the fifth embodiment, the sleeve 58 being sleeved onto the nut of the third embodiment is illustrated for example only and the sleeve 58 can alternatively be sleeved onto the nut of either of other preferred embodiments not limited to that of the third embodiment.

The other structural features and effects of the fifth embodiment are identical to those of the third embodiment, so further recitation is skipped.

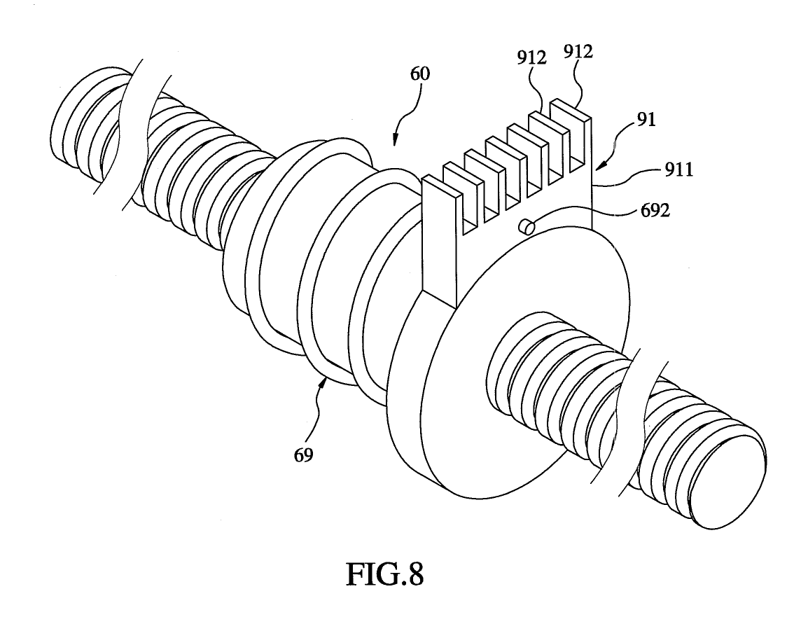

Referring to FIG. 8, a ball screw assembly 60 based on heat-pipe thermal dissipation in accordance with a sixth preferred embodiment of the present invention is similar to that of the first preferred embodiment, having the differences recited in the following paragraphs.

The extended part 692 of the heat pipe 69 is connected to a heat-dissipating device 91, which is a heat sink having a substrate 911 and a plurality of fins 912 extending toward one side from the substrate 911. The extended part 692 is inserted into the substrate 911. In this way, the heat transferred to the extended part 692 can be effectively dissipated via the substrate 911 and the fins 912 because of increased heat-dissipating area.

In the sixth embodiment, the heat-dissipating device 91 being connected with the extended part 692 of the first embodiment is illustrated for example only and the heat-dissipating device 91 can alternatively be connected with the extended part 192 of either of the other embodiments not limited to that of the first embodiment.

The other structural features and effects of the sixth embodiment are identical to those of the first embodiment, so further recitation is skipped.

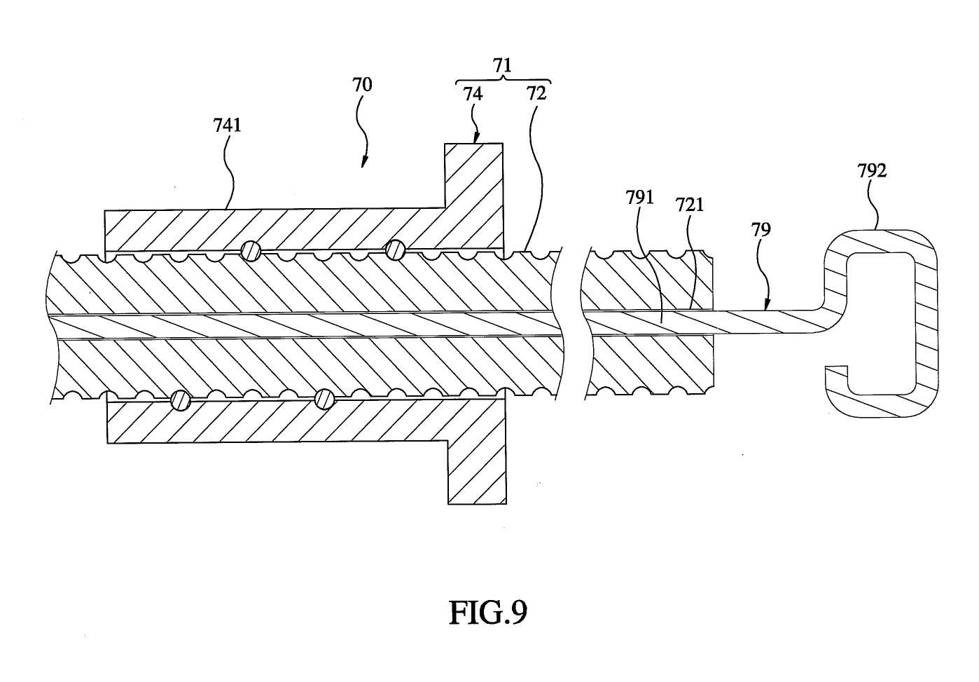

Referring to FIG. 9, a ball screw assembly 70 based on heat-pipe thermal dissipation in accordance with a seventh preferred embodiment of the present invention is similar to that of the first preferred embodiment, having the differences recited in the following paragraphs.

The threaded screw 72 includes a through hole 721 running therethrough along an imaginary axis thereof.

The main body 791 of the heat pipe 70 is not mounted to the barrel 741 but fixedly inserted into the through hole 721.

In light of the above, the heat generated while the ball screw 71 is operated can increase the temperature of the threaded shaft 72. High-speed temperature equalization is characteristic of the heat pipe 79, so the heat of the heat pipe 79 can be quickly conducted to the extended part 192 from the main body 791. When the threaded shaft 72 is rotated, the extended part 792 can be moved in the air, so the heat can be taken away by the air for the purpose of thermal dissipation.

The other structural features and effects of the seventh embodiment are identical to those of the first embodiment, so further recitation is skipped.

It is to be noted that the present invention though applies the aforesaid art of thermal dissipation to the ball screw but the art of thermal dissipation can also be applied to roller screws because the roller screw is technically similar to the ball screw. Thus, the roller screw falls within the scope of claim of the present invention.

In addition, in the first embodiment, the main body of the heat pipe is soldered onto the barrel of the nut by solder, so the contact area between the heat pipe and the nut can be increased due to the solder disposed therebetween to further result in preferably effective thermal conduction between the heat pipe and the nut. The art of the soldering can also be applied to the other embodiments not limited to the first embodiment.

Although the present invention has been described with respect specific preferred embodiments thereof, it is in no way limited to the specifics of the illustrated structures but changes and modifications may be made within the scope of the appended claims.

What is claimed is:

1. A ball screw assembly based on heat-pipe thermal dissipation, comprising:
a ball screw having a threaded shaft, a nut, and a plurality of balls mounted between the threaded shaft and the nut; and
at least one heat pipe defined as a main body and an extended part, the main body being mounted to the ball screw, the extended part extending outwardly for a predetermined length from the ball screw for thermal dissipation or connection with a heat-dissipating device.

2. The ball screw assembly as defined in claim 1, wherein the main body of the at least one heat pipe is mounted to the nut.

3. The ball screw assembly as defined in claim 1, wherein the threaded shaft comprises a through hole running through an imaginary axis thereof; the main body of the at least one heat pipe is fixedly inserted into the through hole.

4. The ball screw assembly as defined in claim 1, wherein the threaded shaft comprises a barrel; the main body of the at least one heat pipe is spirally mounted to an external surface of the barrel.

5. The ball screw assembly as defined in claim 4, wherein the main body of the at least one heat pipe is soldered onto the external surface of the barrel by solder.

6. The ball screw assembly as defined in claim 4, wherein the barrel comprises a spiral groove formed on the external surface thereof; the main body of the at least one heat pipe is wedged into the spiral groove.

7. The ball screw assembly as defined in claim 4, wherein the spiral groove comprises an arc-shaped bottom side.

8. The ball screw assembly as defined in claim 7, wherein the bottom side of the spiral groove fits an external surface of the at least one heat pipe in radian.

9. The ball screw assembly as defined in claim 4, wherein the bottom side of the spiral groove is flat; the at least one heat pipe is squeezed to have two opposite flat external surfaces, one of the opposite flat external surfaces of the at least one heat pipe clinging to the bottom side of the spiral groove.

10. The ball screw assembly as defined in claim 9, wherein the spiral groove is higher than the at least one heat pipe; while mounted into the spiral groove, the at least one heat pipe does not protrude beyond the external surface of the barrel.

11. The ball screw assembly as defined in claim 1, wherein the at least one heat pipe is two in number, each of the two heat pipes having the main body be mounted to the nut.

12. The ball screw assembly as defined in claim 1 further comprising a sleeve, wherein the sleeve is sleeved onto the barrel of the nut and covers the main body of the at least one heat pipe.

13. The ball screw assembly as defined in claim 1, wherein the heat-dissipating device is a heat sink having a substrate and a plurality of fins extending toward a side from the substrate; the extended part of at least one heat pipe is inserted into the substrate.
